(19) United States
(12) Patent Application Publication
(10) Pub. No.: US 2014/0297900 A1
(43) Pub. Date: Oct. 2, 2014

(54) Method for tracking wired and wireless audio peripherals using unique volume key identifiers on a host device

(71) Applicants: Christopher Gary Herbert, Carlsbad, CA (US); Ronald Lance Justin, Santa Barbara, CA (US)

(72) Inventors: Christopher Gary Herbert, Carlsbad, CA (US); Ronald Lance Justin, Santa Barbara, CA (US)

(73) Assignee: PHONE HALO LLC, Santa Barbara, CA (US)

(21) Appl. No.: 13/855,315

(22) Filed: Apr. 2, 2013

(51) Int. Cl. G06F 11/30

(52) U.S. Cl. CPC G06F 11/3051
USPC 710/16

(57) ABSTRACT

A method of an application to identify wireless peripherals in an iOS environment or other environment when peripheral identification information such as address is limited or not available. The application assigns a unique identifier to each peripheral as it connects to a wireless network such as Bluetooth. The unique identifier is a settable/readable parameter that the operating system assigns as a property to the wireless peripheral, for example audio volume. The application assigns a unique value to the identifier for each peripheral, and if the parameters are equal for two or more peripherals, the values are slightly adjusted to be different. The application is particularly useful for keeping track of multiple Bluetooth headsets.

### RELATED APPLICATIONS

This Application claims priority to U.S. Provisional Application Ser. No. 61/619,855, filed Apr. 3, 2012

### BACKGROUND OF THE INVENTION

The use of devices running mobile operating systems, such as Apple iOS, Google Android, and other operating systems, has dramatically risen in the last few years. These devices are capable of Bluetooth and other wireless types of communications as well as running multiple native and third-party software application level programs continuously in the background. Application software is a large secondary market for mobile devices and has greatly contributed to the increase in mobile device adoption by consumers and businesses. Many inventors have conceived of applications to track, locate, and find Bluetooth or other wirelessly enabled peripherals using an application running on a mobile device. However, some operating systems, such as iOS, limit the wireless connection information available to the application level software which makes it difficult to track wireless peripherals. There are many mobile operating systems that limit wireless data to application level software and iOS is an example of how this invention can be applied. The current iOS software does not allow for application level software to read the Bluetooth address or even be aware if a Bluetooth peripheral is connected without having a special Apple provided chipset, increasing the cost of goods sold of such a peripheral. There is a need to develop software that can track any Bluetooth enabled and other wireless peripherals using a mobile application.

### SUMMARY OF THE INVENTION

The current invention is a method for specifically tracking Bluetooth peripherals that utilize the Hands Free Profile or A2DP profile on the iOS operating systems but it could apply to other wired or wireless peripherals that have an audio output. Such peripherals that use these profiles are Bluetooth headsets, Bluetooth speakers, tablets, game systems, laptops, desktops, cars, medical devices, fitness devices, and more. Application software runs on a computer using the iOS operating system and using the audio routing Application Programmer Interfaces (API) available to developers to detect if a Bluetooth peripheral is connected to the computer. The Audio Routing APIs allow developers to access the current audio playback source. For example, using the Audio Routing APIs, the application software can detect if headphones are plugged in and selected as the current audio route for music playback. The software application accesses the audio routing information to determine if a Bluetooth peripheral is currently connected to the iOS computer and this information can be used to convey proximity to the iOS computer. However iOS does not provide information to the application level software of how many devices are currently connected to the mobile device. iOS also does not provide information to the application software to differentiate between multiple Bluetooth devices connected to the mobile device.

With more Bluetooth enabled peripherals available in the market, often a single iOS computer will be connected with multiple Bluetooth peripherals at once or be connected to several different Bluetooth peripherals throughout a day. Due to restrictions within the iOS operating system on Bluetooth low-level control and access for application level software programs, application software is unable to differentiate between unique and individual Bluetooth peripherals. An application level software program that runs on the iOS operating system can only detect that a Bluetooth Audio Route is available and any further information about the audio route is not available to the application. The invention disclosed describes a method that takes advantage of the fact that iOS does give the application level software access to both read and/or write the volume of audio peripherals that are connected to the iOS device. The invention is application level software that tracks the volume state of connected Bluetooth peripherals and uses the volume as a unique identifier to correctly track a specific peripheral or multiple specific peripherals when they reconnect from a disconnection or unselected state.

### BRIEF DESCRIPTION OF THE DRAWINGS

FIG. 1 is a block diagram of a phone and audio end point peripherals

FIG. 2 is a flowchart illustrating the method for detecting a change in the audio routing of the iOS computer

FIG. 3 is a flowchart illustrating the method for determining if actions should be performed after an audio route change.

FIG. 4 is a flowchart illustrating the method for determining the identity of the tracked peripheral

FIG. 5 is a flowchart illustrating the method for assigning a new unique identifier to a peripheral for tracking

### DETAILED DESCRIPTION OF THE INVENTION

It is the object of the present invention to provide a method, embodied in application level software for keeping track of Bluetooth peripherals that utilize the Hands-Free Profile (HFP) or the Advanced Audio Distribution Profile(A2DP) using a computer running the iOS operating system. Developers seek to create applications that interact with multiple Bluetooth peripherals. Such applications include loss prevention for Bluetooth headsets, automatic car parking applications, music applications, and more. Due to the limitations of the iOS operating system for low-level data access and control of Bluetooth peripherals or other wireless audio peripherals, developers have been unable to produce application level software programs that can interact with these peripherals to a degree that is necessary for loss prevention and other applications. The iOS operating system has allowed developers to create application level software programs that can detect the overall presence of a Bluetooth HFP or A2DP peripheral through the operating system's Audio Session API. API's similar to iOS's Audio Session API are present in Android, Windows, and other mobile operating systems. The Audio Session API in iOS allows the application to detect the current audio output route and be notified of immediate changes and the reason why the change has occurred. For example, the application level software program can always query what the current selected audio playback route is and determine whether the audio route is the internal speaker of the mobile device or a Bluetooth headset. However the application level software program cannot use the Audio Session API to query all of the different available audio output types that are currently connected to the mobile device without additional external hardware. The Audio Session API is an example API and it is conceived that other APIs on other operating systems exist that allow applications to access similar data and methods. By utilizing the Audio Session API, developers can create applications that can detect the presence of a Bluetooth HFP or A2DP audio output route, but the developer isn't able to detect or query the presence of a specific Bluetooth peripheral intuitively or directly.

The inventors realized that by using the Audio Session API, changes in the connection status of Bluetooth peripherals with HFP or A2DP capabilities is possible along with the reason why the change occurred. The inventors also realized that the iOS operating system remembers the audio properties of possible audio end points and restores them when such peripherals are selected as the audio output route. The operating system automatically stores the volume level of Bluetooth peripherals when disconnected and when the Bluetooth peripheral becomes connected again to the mobile device, the last stored volume level of the Bluetooth peripheral is restored to be the output volume of the mobile device to the Bluetooth end point peripheral. For example, if a Bluetooth headset is connected to the mobile device and has a volume level of 11, when the Bluetooth headset disconnects from the mobile device, the mobile operating system will record the volume level. When the Bluetooth headset reconnects to the mobile device, the mobile operating system will change the current output volume back to 11 from whatever level it was. The inventors have conceived of a novel method for distinguishing between multiple Bluetooth peripherals that are simultaneously connected to an iOS computer by utilizing the operating system's ability to remember volume levels for output peripherals in combination with user input and the Audio Session API's provided to developers of application level software programs. Thus the audio volume may be used as a unique identifier for peripheral devices.

The implementation works by having application level software run on a user's computer running the iOS operating system. Examples of such computers running the iOS operating system are iPhones, iPod touches, and iPads. It is foreseeable that the iOS operating system could run on a plurality of peripherals and form factors in the future and the type of computer the iOS operating system runs on does not limit the present invention. The application level software running on the iOS device could be downloaded through USB, wirelessly, or can be preinstalled and packaged within the iOS operating system, but executes at run time from processor memory, ie non-transitory operation and is thus patentable subject matter. The application level software uses the Audio Session API to detect if any Bluetooth audio peripheral is present at launch. The call to the Audio Session API method will return a positive Boolean value if a Bluetooth audio peripheral is the currently selected output route. Additionally, an Audio Session API callback will notify the application that the audio route changed and will supply information on the origin of change and what the route is now set to along with reason codes for the change. Upon any audio route change, the iOS operating system automatically sets the volume to what it was for that peripheral upon its last connection.

Upon positive detection of a Bluetooth audio output peripheral being connected to the iOS computer, the software can, if desired, prompt the user to identify the peripheral. The user can directly type in the type of peripheral or select the category of the peripheral from a list. The user is also able to enter in the name of a peripheral that will reference a database of Bluetooth peripherals to categorize the connected peripheral. Upon the user identifying the peripheral, or without user identification the software will query the current audio level of the peripheral after iOS has automatically set the volume to what it was upon a previous connection if there was one. The current audio level is retrieved, stored, and the software begins tracking changes in the audio level of the peripheral. The audio level is associated with the user's identification of the peripheral, or alternatively just identified as a peripheral with a known audio identifier. If the user were to change the volume level of the Bluetooth output peripheral, the software will record this change. If the user device were to become disconnected from the Bluetooth peripheral then reconnect back to the peripheral, the software will compare the audio level of the newly connected peripheral with the current tracked peripheral audio levels. If the audio level matches one of the tracked Bluetooth peripherals, the software will identify the peripheral as the peripheral that was previously connected to the phone or other device. The software ensures the correct identification of the Bluetooth peripheral by comparing the Bluetooth peripheral category that was connected and the last volume data stored by the software to the current output volume of the peripheral set by iOS. If the two parameters match, the software can determine with high certainty that the current Bluetooth peripheral connected is the one being tracked.

To enable the use of assigning and tracking volume id's to be effective, the software keeps track of multiple volume settings and makes sure that no two audio output peripherals may have the same volume settings. If a peripheral is connected and a second peripheral becomes connected to the phone/host device with the same exact volume, the application level software will change the volume of the newly connected peripheral so that it is not equal to the currently tracked peripheral's volume level. The application level software does this by utilizing the Audio Session APIs to write a new volume level to the newly connected device. A change of one micro-unit of volume is allowable by the iOS operating system and is effective for tracking without a noticeable difference to a user. In the case that multiple peripherals are connected to the phone and the user attempts to set the volume of a peripheral equal to that of the other, the software will recognize that two peripherals have equal volumes and will change the volume of the peripheral that was just changed so that it does not equal any other peripheral by utilizing the volume write ability in the Audio Session APIs. The method disclosed of tracking changes of audio volume parameters to create a unique identity value for all tracked peripherals is not limited to only changes in audio volume levels for peripheral devices. Any parameter that a computer's operating system exposes to application level software that is associated with a peripheral and can be read or written to as well as having its values stored automatically by the operating system can be used as a unique identifier to track the peripheral. For example, some Bluetooth headset peripherals have internal hardware gain settings that are readable and writeable by application level software programs. The value is a usually a floating point number and stored by the Operating System's memory. The gain setting for Bluetooth headsets could also be used as a unique identifier.

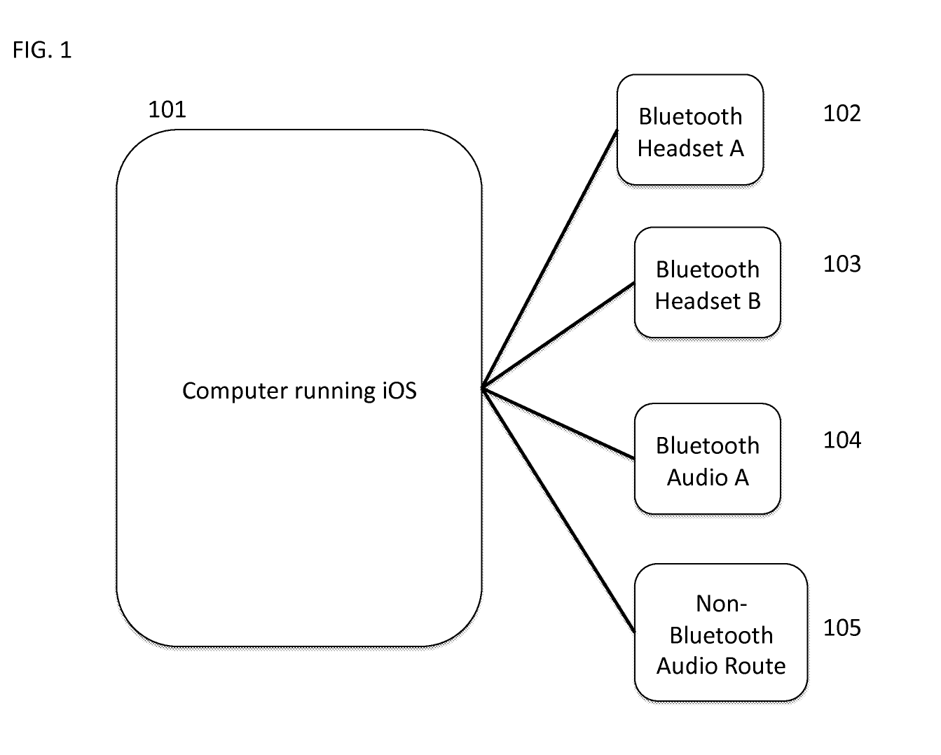

FIG. 1. Illustrates a computer running the iOS operating system (101). Current examples of computers running the iOS operating system are iPhones, iPads, and iPod Touches. It is envisioned that components of the iOS operating system can be ported into a variety of other Operating Systems such as Mac OS X, Windows, and/or Linux and the method described herein will still be applicable. The computer is seen as able to connect with a multitude of audio output peripherals. The application level software is able to run and detect the difference between classes of audio peripherals using the Audio Session API. By querying for audio route changes, the software is able to detect changes in state between Bluetooth HFP peripherals, Bluetooth A2DP peripherals, Headphones, Speakers, Made for iPod (MFi) Speakers, Video Output Displays, and other audio endpoints shown as by example 102-105 in the Figure.

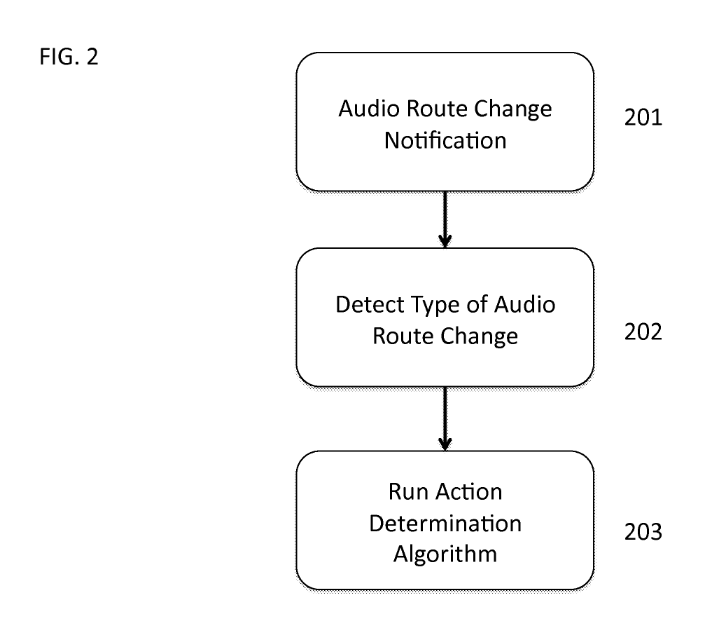

FIG. 2 illustrates the method for detecting audio changes. The software begins processing a change in the audio route (201) by adopting the audio session route change protocol. This protocol allows the software to be notified by the iOS operating system when the audio path taken for output changes between different hardware peripherals. Such examples of possible audio routes are the iPhone speaker audio route, external headphones audio route, and Bluetooth A2DP audio route. The software is notified that there is a change and detects the type of change that occurred (202). Once the type of audio route change has been detected, an algorithm is run by software (203) that determines the appropriate action for the audio route change. Although the current invention focuses on audio route changes dealing with Bluetooth audio paths, the same methods disclosed herein can be applied to detecting changes in any audio route and tracking the state of any audio endpoint such as headphones, MFi speakers, or video displays with audio capabilities. The iOS documentation also outlines the use of a camera kit API that can also detect audio changes but only when an iPad-only dongle is connected to an iPad and hence only works for iPads with said hardware dongle. One skilled in the art can easily determine that the camera kit or other audio related API's could be used to detect changes in audio routing. One skilled in the art could also port the same theories disclosed herein for other operating systems using the appropriate API calls within those operating systems.

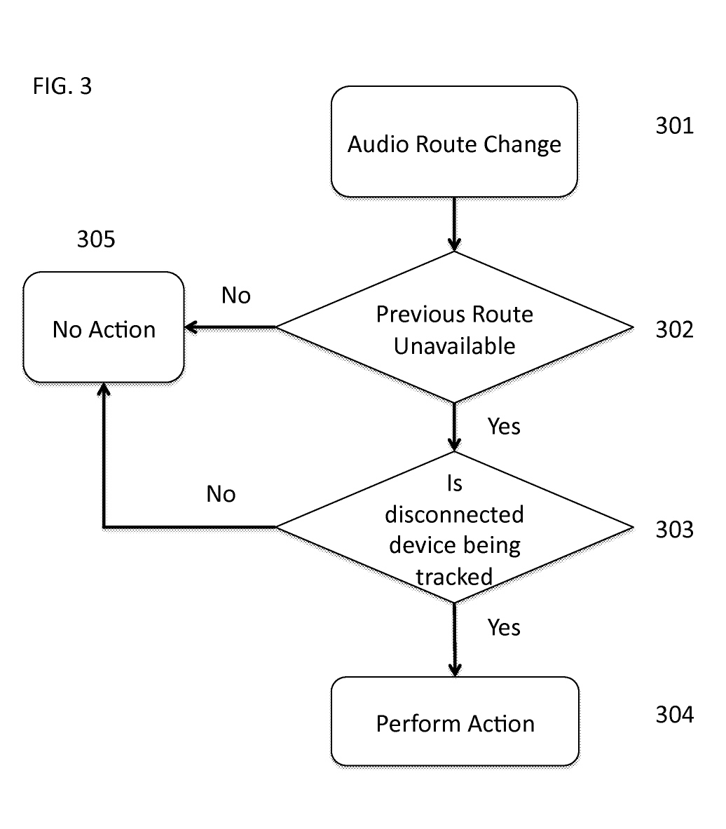

FIG. 3 illustrates the algorithm that runs to determine if an action should occur after a change in the audio routing. The algorithm begins by being notified that the audio routing has changes (301). The algorithm next detects if the cause for the audio routing switch was due to the previous route being unavailable (e.g, a Bluetooth disconnection) (302). This step could detect other actions such as the audio route becoming detected again or a variety of different causes. The audio route not being available is used as an example for detecting changes in the Bluetooth audio availability for a loss prevention application. If the reason behind the audio routing is not of concern, no action occurs (305). In this particular case, if the audio routing change is not due to a Bluetooth audio route source no longer being available, no action shall occur. If the cause for the audio route change is applicable, the algorithm will then detect if the current peripheral that reported their audio routing being changed is currently tracked (303). The software is capable of tracking single or multiple audio end point peripherals. The software can check if the current audio peripheral is currently being tracked by a user and can then determine if the action should be performed. If it is determined that the audio peripheral is not being tracked, no action is performed (305). If it is determined the audio peripheral is currently being tracked, the software will determine the appropriate action to be performed for the audio peripheral (304). An example of such action that could be performed would be in a loss prevention application for Bluetooth headsets or other wirelessly connected peripherals with any kind of audio output capability. An example action the computer could perform would be to ring to alert the user that he/she is leaving behind their wireless headset peripheral.

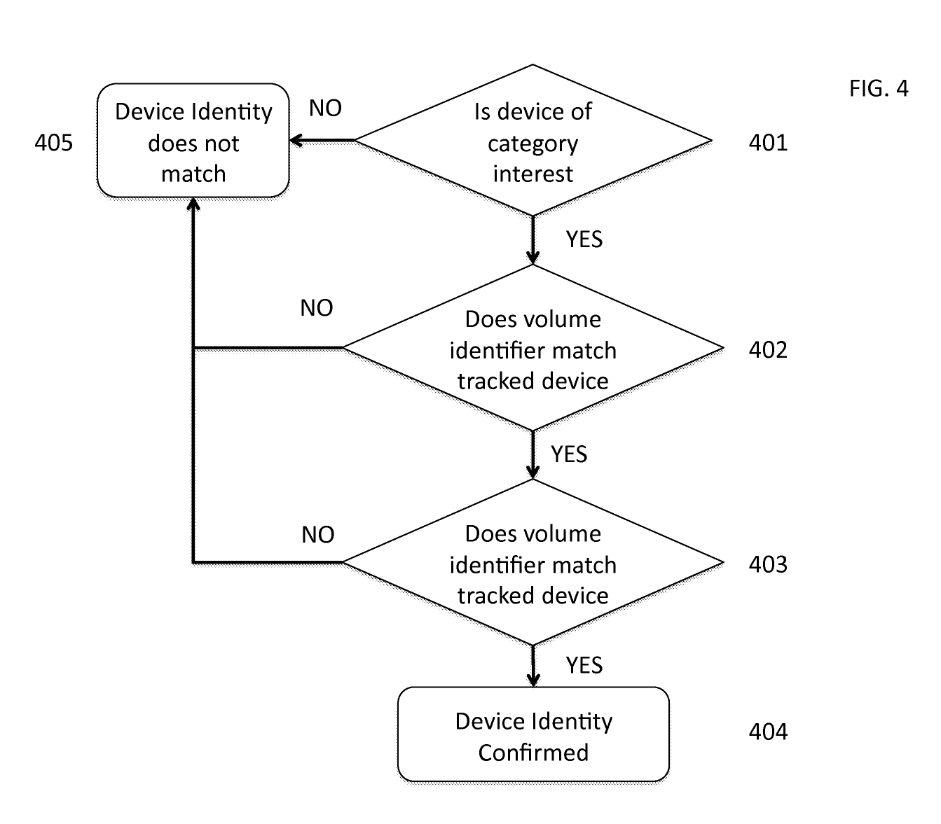

FIG. 4 illustrates the algorithm for determining if the current audio output peripheral is selected by a user to be tracked and the method for confirming the identity of the audio endpoint peripheral. The algorithm begins by detecting if the audio end point is of a category that interests the software (401). For example, in the case of tracking a Bluetooth audio peripheral, the algorithm would check if the category of the peripheral is a Bluetooth HFP or A2DP peripheral. If the current peripheral does not match a category the software is interested in, the software will ignore the peripheral (405) and report that the identity does not match any currently tracked audio end point peripherals. If the category is of interest, the algorithm will check if the current volume identifier matches that of the tracked peripheral (402). The application software program checks if the currently detected peripheral's audio output volume matches a volume level identifier stored in memory. The volume identifier could be a single volume indicated as fixed or floating-point number or an array of fixed or floating point numbers. The software compares the volume of the peripheral to those of the tracked peripherals. It is conceived that margins of error could be applied to determine a match if the volume identifier and volume of the current peripheral are matching within a certain margin of error. If the volume of the current peripheral does not match that of any of the volume identifiers of tracked peripherals that are stored in the iOS computer's program memory, the peripheral will be ignored and the software will report that the peripheral identity does not match (404). If the volume identity matches a volume identifier for a peripheral, the match is confirmed and the software reports the identity match (403).

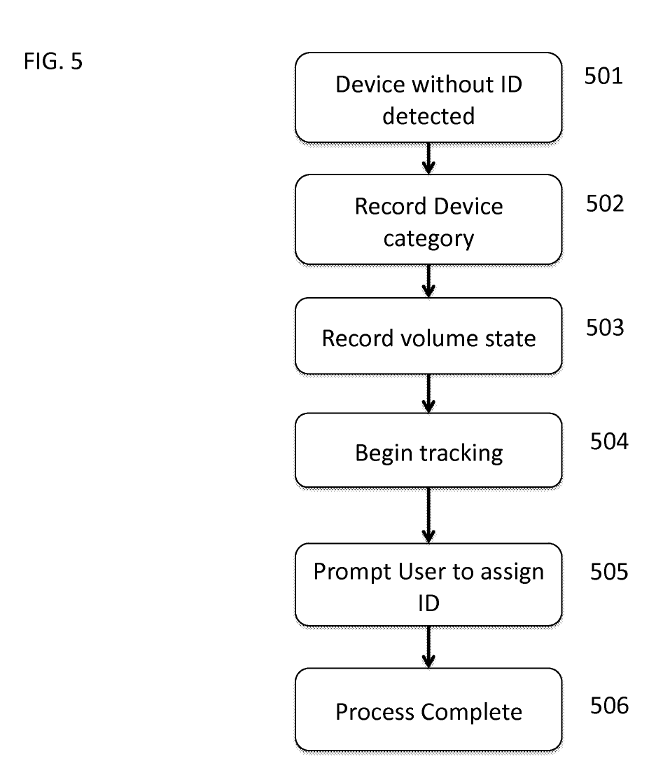

FIG. 5 is a flowchart that illustrates the assignment of a unique volume ID to a new audio peripheral. The process begins when a new peripheral without a unique ID is recognized by the software (501). It is determined by the software that the new peripheral is without an ID and there is no match to any volume identifiers currently being tracked by the software or the software does not currently track the peripheral category. The software records the peripheral category (502) and records the volume value (503). The software in a database such as an sql lite database records the peripheral category and volume state. The database could be on the phone or stored in the cloud. The software begins tracking the volume state of the peripheral (504) to use as a unique identifier. The software then prompts the user to assign an id to the peripheral (505). This id could be typed in or selected from a list. This id is used to differentiate the peripheral from other similar category peripherals and can be used for generating a unique user interface. After the user has generated an id for the peripheral, the process is complete (506). It should be noted that the user identification is not necessary for any of the tracking and identifying aspects of the invention the invention can still differentiate and track peripherals whether or not the user has labeled them.

We claim:

1. A method for an application executing on a computer running an operating system, which limits peripheral identifier information, and which has a wireless network capability to determine the presence of a wireless peripheral, comprising;
setting a parameter that the operating system stores in memory as a property of the wireless peripheral to be used as a unique identifier
saving the parameter in memory; and,
tracking the parameter via the operating system, wherein;
the parameter is read by the application to identify individual wireless peripherals after a wireless peripheral has become connected to the wireless network and when the wireless peripheral becomes disconnected from the wireless network.

2. Method of claim 1 wherein the unique identifier is the audio volume of the wireless peripheral

3. Method of claim 2 wherein the wireless peripheral is a Bluetooth peripheral capable of playing audio, and the wireless network is Bluetooth.

4. Method of claim 3 where the unique identifier is compared to an application database of unique identifiers to determine if the application should perform actions when the wireless peripheral connects or disconnects from the network.

5. Method of claim 3 where the unique identifier is compared to a application database and confirms the identity of the wireless peripheral.

6. Method of claim 3 where if the unique identifier to be assigned to a wireless peripheral is equal to another wireless peripheral unique identifier, the application will adjust the system value of the unique identifier of the wireless peripheral and store the new unique identifier.
